(19) United States
(12) Patent Application Publication
(10) Pub. No.: US 2021/0359925 A1
(43) Pub. Date: Nov. 18, 2021

(54) TECHNIQUE FOR DETERMINING PERFORMANCE OF INDUSTRIAL PROCESS CONTROL

(71) Applicant: Telefonaktiebolaget LM Ericsson (publ), Stockholm (SE)

(72) Inventors: Attila BÁDER, Paty (HU); Sándor RÁCZ, Cegléd (HU); Geza SZABO, Kecskemet (HU)

(21) Appl. No.: 17/272,571

(22) PCT Filed: Sep. 7, 2018
(86) PCT No.: PCT/EP2018/074179

§ 371 Date: Mar. 1, 2021

(51) Int. Cl. H04L 12/26; H04W 24/04

(52) U.S. Cl. CPC H04L 43/08; H04W 24/04

(57) ABSTRACT

A technique for determining performance of industrial process control is provided, wherein local controllers of the industrial process are coupled via a wireless communication network to a central controller and supervised by a supervisory system that captures operational information from the local controllers. A method implementation of the technique includes receiving first event records captured from the wireless communication network, receiving second event records captured from the supervisory system, correlating at least the first and second event records that pertain to substantially the same period of time in a correlation record, and determining a performance indicator on the basis of information included in one or more correlation records.

### TECHNICAL FIELD

The present disclosure generally relates to industrial automation. In particular, a technique for determining performance of industrial process control is presented, wherein a local controller of the industrial process is coupled via a wireless communication network to a central controller and is supervised by a supervisory system. The technique may be implemented in the form of an apparatus, a method, and a computer program product.

### BACKGROUND

In industrial automation, robot cells are built from robotic devices and the robotic devices are controlled using local controllers within the robot cells. The local controllers, in turn, can be controlled from a remote site by a central controller. The central controller can, for example, be deployed in a computing cloud, and control commands generated by the central controller in the computing cloud can be wirelessly transmitted to the robot cells.

Existing communication protocols for industrial automation (e.g., EtherCAT or ProfiNet) have been developed for situations in which the central controller is situated in the robot cell and connected to the local controllers via wire-based field buses. These protocols assume that command transmission from the central controller to the local controllers is reliable and has no substantial delay.

Field buses are not impacted by the challenges of wireless command transmission, including packet loss, jitter, wireless spectrum availability, re-transmission delay, and proper resource allocation. Wireless command transmission negatively impacts the deterministic behaviour of robot cell control compared to wire-based solutions.

Control logic of an industrial process such as a robot cell runs on local controllers like hardware Programmable Logic Controllers (PLCs) and discrete Proportional Integral Differential (PID) controllers. PLCs, and local controllers in general, are highly reliable computing devices with relatively low processing power and designed to control a single robotic device, a robot cell, a complete production line or any other industrial process.

Local controllers require low jitter and a reliable network connection to operate in firm deadline mode, which is difficult to obtain in case of wireless command transmission. The firm real-time definition of deadlines allows for infrequently missed deadlines. In such applications the control system can survive task failures so long as they are adequately spaced. However the value of task completion drops to zero or becomes impossible.

Supervisory Control And Data Acquisition (SCADA) is a control system architecture that uses computers, networked data communications and graphical user interfaces for high-level process supervisory management, but uses the local controllers such as PLCs as peripheral devices to interface with the industrial process. SCADA operator interfaces enable monitoring and issuing of process commands, such as controller set point changes. Real-time control logic and controller calculations, on the other hand, are executed by the local controllers, which connect to field sensors, robot actuators, and so on.

The SCADA concept was developed as a universal means of remote access to a variety of local controllers, which could be from different manufacturers allowing control access through standard automation protocols. In practice, large SCADA systems have grown to become very similar to distributed control systems in function, but using multiple means of interfacing with the industrial process. They control large-scale processes that can include multiple sites, and work over large as well as small distances.

SCADA also allows for monitoring performance of local controllers. In parallel, performance of the wireless communication network used for wireless command transmission is often monitored. It remains, however, a challenge to attribute a performance degradation of the controlled industrial process as a whole to a particular root cause.

### SUMMARY

There is a need for a technique of reliably determining the performance of industrial process control.

According to a first aspect, an apparatus configured to determine performance of industrial process control is provided, wherein at least one local controller of the industrial process is coupled via a wireless communication network to a central controller and wherein the at least one local controller is supervised by a supervisory system that captures operational information from the at least one local controller. The apparatus is configured to receive first event records captured from the wireless communication network, to receive second event records captured from the supervisory system, to correlate at least the first and second event records that pertain to substantially the same period of time in a correlation record, and to determine at least one first performance indicator on the basis of information included in one or more correlation records.

The first event record and the second event record, as well as any further event record, may each be a dedicated data record or any other data structure generated by linking one or more first event records with one or more second event records.

Each event record may include a time stamp or other time-related information indicative of when the event record, including the information contained therein, was captured. The time stamp or other time-related information may be used for correlation purposes.

The apparatus may be configured to evaluate the at least one first performance indicator to identify a performance issue. A performance issue may be identified if the performance indicator violates a threshold condition (e.g., exceeds or falls below a given threshold).

If a performance issue is identified, the apparatus may determine a system domain in which the performance issue has occurred. The system domain may be selected from at least a wireless access domain and a local controller domain. The wireless access domain may include the wireless communication network. The local controller domain may include the at least one local controller.

In one implementation, the at least one first performance indicator relates to a high system level. If a system issue has been identified, one or more second performance indicators relating to a low system level may be analyzed to determine the system domain in which the performance issue has occurred. The high system level may not permit to determine the system domain that has caused the performance issue, so that a further analysis on the low system level is still necessary for root cause analysis of the performance issue.

The first performance indicator on the high system level may relate to a conformity level of industrial process control (e.g., of a protocol utilized for controlling the industrial process, such EtherCAT or ProfiNet). The performance issue may be identified when the conformity level indicated by the first performance indicator violates an associated conformity threshold.

The one or more second performance indicators may permit a root cause analysis of the performance issue. In particular, the one or more second performance indicators may be measurement values. The associated measurements can be performed in the wireless access domain and in the local controller domain.

The one or more second performance indicators may be selected from the group comprising at least Reference Signal Received Power, RSRP, Reference Signal Received Quality, RSRQ, handover execution time, packet loss, transmit power, a Hybrid Acknowledgement Repeat Request-, HARQ-, related parameter, Signal-to-Interference-plus-Noise Ratio (SINR), supervisory system Web access time, video buffering time of a camera monitoring the industrial process, video stall time of the camera, supervisory system alarms, and diagnostics information from the supervisory system. The one or more second performance indicators may be received with one of the first event records, one of the second event records, a third event record captured by the camera, or a combination thereof.

The apparatus may be configured to report the performance issue dependent on the system domain in which the performance issue has occurred. The performance issue may be reported to an Operations Support System, OSS, of the wireless communication network if the performance issue is attributable to the wireless access domain. Additionally, or in the alternative, the performance issue may be reported to at least one of the supervisory system and an incident management system of the industrial process if the performance issue is attributable to the local controller domain.

The at least one local controller may be located on level 1 of the Open Systems Interconnection, OSI, model. Additionally, or in the alternative, the supervisory system may be located on level 2 of the OSI model. The at least one local controller may be connected to the supervisory system via a communication technique different from the wireless communication network. This communication technique may be wire-based (e.g., it may be based on a field bus).

The at least one local controller may have an operating cycle. A processor of the local controller may define the operating cycle. The period of time underlying an individual correlation process may have a duration that corresponds to one or multiple operating cycles of the at least one local controller.

In certain implementations, at least some of the first event records may be indicative of at least one of a radio condition-related parameter, a mobility-related parameter, and a user plane traffic-related parameter. In such or in other implementations, at least some of the second event records may be indicative of an event (e.g., an alarm event) generated by the supervisory system based on the operational information captured from the at least one local controller. The operational information may relate to a parameter indicative of an operational status of the at least one local controller.

The apparatus may be configured to perform the receiving and correlating operations in real-time. As such, the first performance indicator may be obtained in real-time. The apparatus may be configured adjust at least one operational parameter of the at least one local controller based on an analysis of the at least one first performance indicator. This adjustment may also be performed in real-time.

The at least one first performance indicator may be based on a parameter of an industrial communication protocol utilized by one or more devices (e.g., one or more local controllers) involved in the industrial process. The industrial communication protocol may be utilized on communication links between a local endpoint of the wireless communication network and the devices involved in the industrial process. As an example, the at least one first performance indicator may be selected from the group comprising at least
a profile conformity level for the industrial communication protocol;
a synchronization level for one or more devices involved in the industrial process;
an occupied Transmission Time Interval-, TTI-, related parameter due to bandwidth reservation for frames of the industrial communication protocol; and
a scheduler preemption-related parameter for frames of the industrial communication protocol.

The apparatus may be configured to receive one or more third event records captured from at least one monitoring device that monitors the industrial process. The monitoring device may be a sensor (e.g., a motion or angular sensor), a camera, and so on.

The apparatus may be configured to correlate at least the first, second and third event records that pertain to substantially the same period of time in the correlation record. The one or more third event records may be indicative of at least one of a measurement parameter from a sensor associated with an actuator controlled by the at least one local controller, and information relating to a camera having a field of view including at least a part of the industrial process.

The one or more third event records may be received via the wireless communication network. Additionally, or in the alternative, two or more monitoring devices may be configured to transmit their third event records via different wireless links to the wireless communication network. The apparatus may then be configured to perform the correlation per monitoring device.

Generally, the at least one local controller may be a Programmable Logic Controller, PLC. The supervisory system may be a Supervisory Control and Data Acquisition, SCADA, system.

The central controller may be located in a computing cloud. The apparatus may be implemented via cloud computing resources.

According to a second aspect, a method for determining performance of industrial process control is provided, wherein at least one local controller of the industrial process is coupled via a wireless communication network to a central controller and wherein the at least one local controller is supervised by a supervisory system that captures operational information from the at least one local controller. The method comprises receiving first event records captured from the wireless communication network, receiving second event records captured from the supervisory system, correlating at least the first and second event records that pertain to substantially the same period of time in a correlation record, and determining at least one performance indicator on the basis of information included in one or more correlation records.

The method presented herein may be performed by an apparatus as generally described above and as described below in more detail.

Also provided is a computer program product comprising program code portions for performing the steps of any of the method aspects presented herein when executed by one or more processors. The computer program product may be stored on a computer-readable recording medium. The computer program product may also be provided for download via a network connection.

Also presented is a cloud computing system configured to perform any of the method aspects presented herein. The cloud computing system may comprise distributed cloud computing resources that jointly perform the method aspects presented herein under control of one or more computer program products.

### BRIEF DESCRIPTION OF THE DRAWINGS

Further aspects, details and advantages of the present disclosure will become apparent from the detailed description of exemplary embodiments below and from the drawings, wherein:

FIG. 1 illustrates a first network system embodiment of the present disclosure;

FIGS. 2A & B illustrate apparatus embodiments of the present disclosure;

FIG. 3 illustrates a method embodiment of the present disclosure;

FIG. 4 illustrates a further network system embodiment of the present disclosure; and

FIG. 5 illustrates a flow diagram of an embodiment for performing root cause analysis.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

While, for example, the following description focuses on specific radio access network types such as 5^{th} Generation (5G) networks, the present disclosure can also be implemented in connection with other radio access network types. Moreover, while certain aspects in the following description will exemplarily be described in connection with cellular networks, particularly as standardized by the 3^{rd} Generation Partnership Project (3GPP), the present disclosure is not restricted to any specific wireless access type. While some of the embodiments are explained using ProfiNet as an exemplary industrial communication protocol, the present disclosure can also be implemented using other industrial communication protocols such as EtherCAT.

Those skilled in the art will further appreciate that the steps, services and functions explained herein may be implemented using individual hardware circuitry, using software functioning in conjunction with a programmed microprocessor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numerals denote the same or similar components.

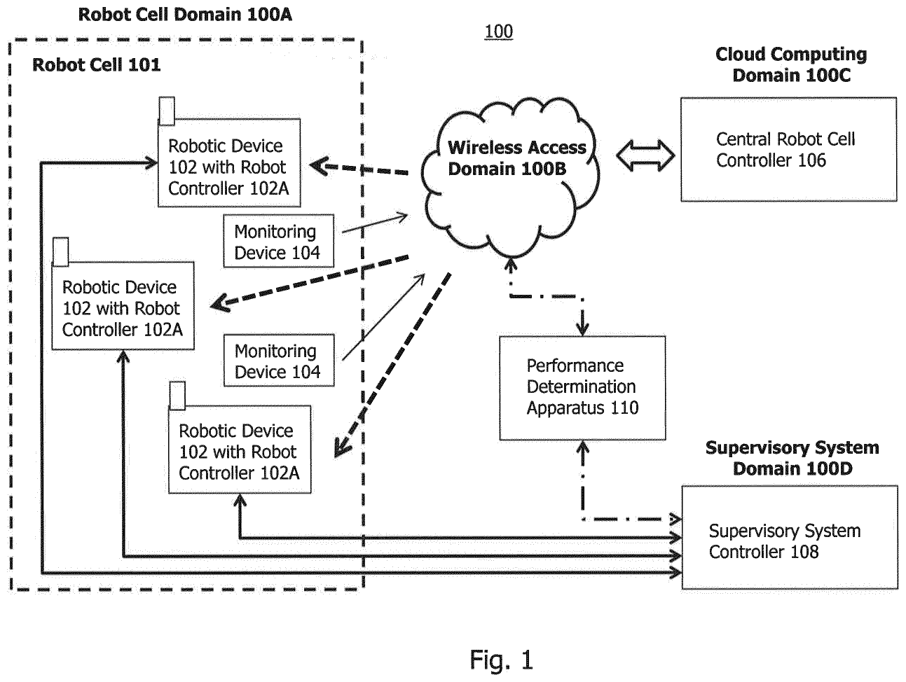

FIG. 1A illustrates an embodiment of a network system 100 for computing cloud-based robot cell control. As shown in FIG. 1A, the network system 100 comprises a robot cell domain 100A, a wireless access domain 100B, a cloud computing domain 100C and a supervisory system domain 100D. In some variants, the supervisory system domain 100D may be located in the cloud computing domain 100D. In other variants, the supervisory system domain 100D may be located in the robot cell domain 100A.

The robot cell domain 100A, as one example of an industrial process, comprises at least one robot cell 101 with multiple robotic devices 102 each having a dedicated local robot controller 102A in association therewith. The present disclosure could also be implemented in the context of chemical process control or control of any other industrial process.

The robotic devices 102 comprise various actuators such as robot arms movable within various degrees of freedom. The robotic devices 102 within the robot cell 101 may collaboratively work on the same task (e.g., on the same work product).

The local robot controllers 102A may be hardware PLCs, discrete PID controllers, or similar devices. Each local controller 102A may comprise one or more Central Processing Units (CPUs). Each local controller 102A may comprise one or more Input/Output (I/O) units. These I/O units may be configured for wired connection to a wireless endpoint within the robot cell 101 (not shown) towards the wireless access domain 100B. In general, the local controllers 102A will functionally be located on OSI level 1 (physical level).

The robot cell domain 100A further comprises multiple monitoring devices 104 such as cameras, position sensors, orientation sensors, angle sensors, and so on. The monitoring devices 104 generate state data indicative of a state of the robot cell 101. The monitoring devices 104 can be freely distributed in the robot cell 101. One or more of the monitoring devices 104 can also be integrated into one or more of the robotic devices 102. Moreover, in some variants also the local controllers 102A may function as monitoring devices 104 capable of generating state data indicative of a state of the robotic devices 102.

The wireless access domain 100B may comprise one or more cellular and/or non-cellular communication networks, such as a cellular network specified by 3GPP (e.g., a 4G or 5G cellular network). In some implementations, the wireless access domain 100B may be compliant with the 3GPP standards according to Release R15, such as TS 23.503 V15.1.0 (2018-3) or later. The wireless access domain 100B may comprise one or more base stations and/or one or more wireless access points (not shown in FIG. 1) that enable a wireless communication between components of the robot cell 101 on the one hand and the cloud computing domain 100C on the other via the wireless access domain 100B.

As illustrated in FIG. 1A, the robotic devices 102 with their associated local robot controllers 102A are configured to receive control commands generated in the cloud computing domain 100C via wireless transmissions from the wireless access domain 100B. Moreover, the state data as acquired by the monitoring devices 104 are wirelessly communicated via the wireless access domain 100B to the cloud computing domain 100C and, optionally, the supervisory system domain 100D to inform same about the state of the robot cell 101. Processing of the state data may be performed in the context of inverse kinematics, in a robot cell security context or in the present context of performance monitoring and control.

The cloud computing domain 100C comprises a central robot cell controller 106 composed of could computing resources. The central robot cell controller 106 is configured to receive the state data from the monitoring devices 104 via the wireless access domain 1008. The central robot cell controller 106 is further configured to generate control commands for the robotic devices 102, optionally on the basis of the data from the monitoring devices 104, and to forward the control commands via the wireless access domain 100B to the local controllers 102A of the robotic devices 102. The local controllers 102A are configured to wirelessly receive the control commands and to control one or more individual actuators of the respective robotic device 102 based thereon.

The supervisory system domain 100D comprises a supervisory system controller 108 connected to the individual local controllers 102A in the robot cell 101. The supervisory system controller 108 will in general be located on OSI level 2.

The supervisory system controller 108 provides graphical and non-graphical user interfaces for high-level process supervisory management using the local controllers 102A as peripheral devices to interface with the robot cell 101. The supervisory system controller 108 enables monitoring and issuing of commands, such as controller set point changes. In some variants, the supervisory system controller 108 may be integrated into the central robot cell controller 106. In other variants, the supervisory system controller 108 may be located in the robot cell domain 100A (e.g., in the robot cell 101). In the latter case, the supervisory system controller 108 may be coupled to the robot controllers 102A via wire-based connections (e.g., a field bus). The supervisory system controller 108 may be configured in accordance with the SCADA paradigm.

As illustrated in FIG. 1, the network system 100 further comprises a performance determination apparatus 110 configured to determine control performance in the robot cell 101. In particular, performance of the industrial process controlled by the local controllers 102A will be determined. Control performance mainly depends on performance of the wireless access domain 100B that is used for wireless command transmission to the local controllers 102A, and on performance of the local controllers 102A themselves in the context of executing the wirelessly transmitted commands. To gather, or capture, the associated performance information in the form of so-called event records, the performance determination apparatus 110 is coupled to the wireless access domain 100B on the one hand and, on the other hand, to the supervisory system domain 100D. In many realizations, the performance determination apparatus 110 will directly or indirectly be coupled to multiple capturing points within the wireless access domain 100D. The performance determination apparatus may additionally receive state data from the monitoring devices 104.

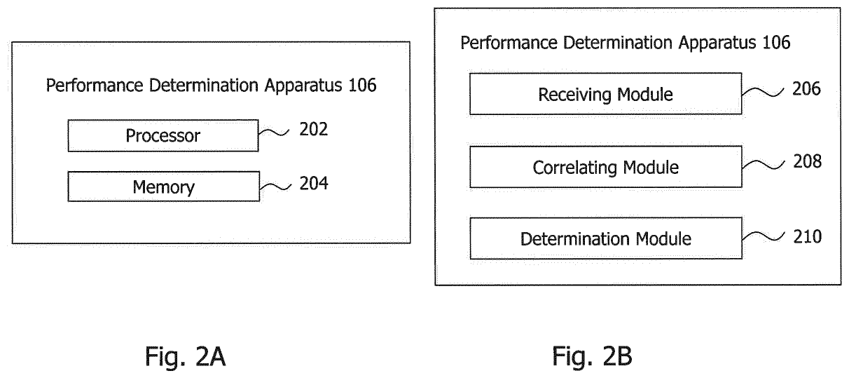

FIGS. 2A and 2B illustrate two embodiments of the performance determination apparatus 110 of FIG. 1. In the embodiment illustrated in FIG. 2A, the apparatus 110 comprises a processor 202 and a memory 204 coupled to the processor 202. Optionally, the apparatus 110 further comprises one or more interfaces for communication with other components of the network system 100 of FIG. 1, in particular with the wireless access domain 100B and the supervisory system domain 100D.

The processor 202 is configured to receive first event records captured from the wireless access domain 100B, to receive second event records captured from the supervisory system domain 100D, to correlate in a correlation record at least the first and second event records that pertain to substantially the same period of time, and to determine at least one first performance indicator for one or more of the local controllers 102A on the basis of information included in the one or more correlation records.

FIG. 2B shows an embodiment in which the performance determination apparatus 110 is implemented in a modular configuration. As shown in FIG. 2B, the apparatus 110 comprises a receiving module 206 configured to receive first event records captured from the wireless access domain 100B and to receive second event records captured from the supervisory system domain 100D. The apparatus 110 further comprises a correlating module 208 configured to correlate in a correlation record at least the first and second event records that pertain to substantially the same period of time and a determination module 210 configured to determine at least one first performance indicator for one or more of the local controllers 102A on the basis of information included in one or more correlation records.

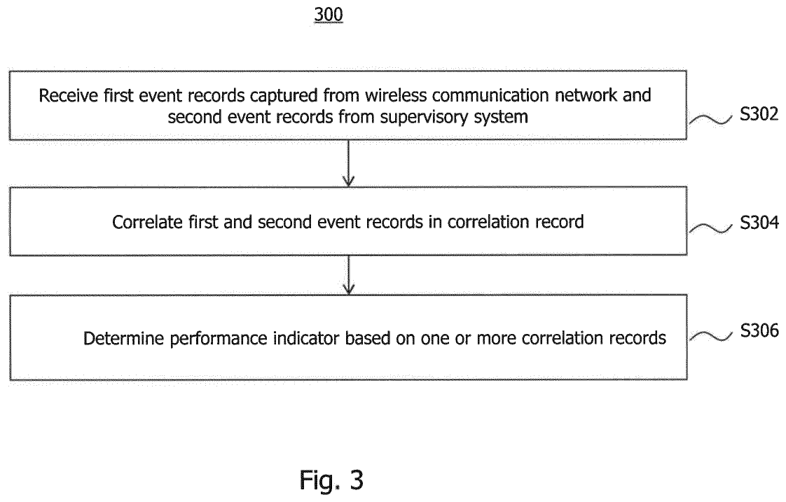

FIG. 3 illustrates in a flow diagram 300 a method embodiment of performance determination in regard of the industrial process taking place in the robot cell 101. The method embodiment may be performed by any of the apparatus embodiments of FIG. 2A or 2B, or by an apparatus having another configuration.

In step S302, the apparatus 110 receives first event records captured from the wireless access domain 100B and second event records captured from the supervisory system domain 100D. Optionally, the apparatus further receives third event records captured from the monitoring devices 104 in the robot cell domain 100A.

The first and second event records, and any further event records, may be received in any order. The event records may be received in real-time. As such, the apparatus 110 may receive continuous stream of event records. In the present embodiment, each event record comprises a time stamp or other timer-related information indicative of the point in time when the information in the event record was captured.

In step S304, the apparatus 110 correlates the received first and second event records (and the optional third event records). To this end, the apparatus 110 evaluates the time stamp or other time-related information in the event records to be correlated so as to determine a subset of the received first and second (and, optionally, third) event records that pertain to substantially the same period of time. The period of time may be defined by a time window having a limited temporal extension (e.g., in a sub-second regime). The period of time that defines the event record subset underlying a particular correlation record can be selected to correspond to one operating cycle of a local controller 102A. Of course, also other correlation time resolutions may be selected, such a predefined number of two or more operating cycles.

The subset of received first and second (and, optionally, third) event records thus determined is aggregated in a correlation record. The correlation record may be a separate data record into which at least some of the information captured in the subset of first and second (and, optionally, third) event records that pertain to substantially the same period of time is included. In another realization, the correlation record is created by linking the subset of first and second (and, optionally, third) event records that pertain to substantially the same period of time, wherein the linked event records represent the correlation record.

In a further step S306, information included in one or more of the correlation records obtained in step S304 are analyzed to determine at least one performance indicator, such as a Key Performance Indicator (KPI). The performance indicator may in particular be indicative of a conformity level in regard to robot cell control. For example, the conformity level may pertain to an industrial communication protocol such as ProfiNet used in the robot cell 101 on links between a local endpoint of the wireless access domain 100B within the robot cell 101 on the one side and the local controllers 102A on the other side. The conformity level thus obtained, or the performance indicator in general, may be subjected to a threshold decision to determine whether or not a performance issue is present that requires a root cause analysis.

With the approach depicted in FIG. 3, root cause analysis is facilitated. Assume that the high-level performance indicator derived from the correlation records indicates that a ProfiNet-based conformity level violates in 2% of all cases a predefined conformity threshold. By then analyzing low-level performance indicators pertaining to more fine-grained information also included in the associated correlation records, it can be seen that 80% of all conformity violations are due to radio transmission problems (e.g., because of significant packet losses). This fact clearly indicates that the root cause for the conformity level violations can be found in the wireless access domain 1008, rather than in the robot cell domain 100A with the local controllers 102A. By selectively analyzing the low-level performance indicators only if a threshold violation in regard to a high-level performance indicator has occurred, processing resources can be saved.

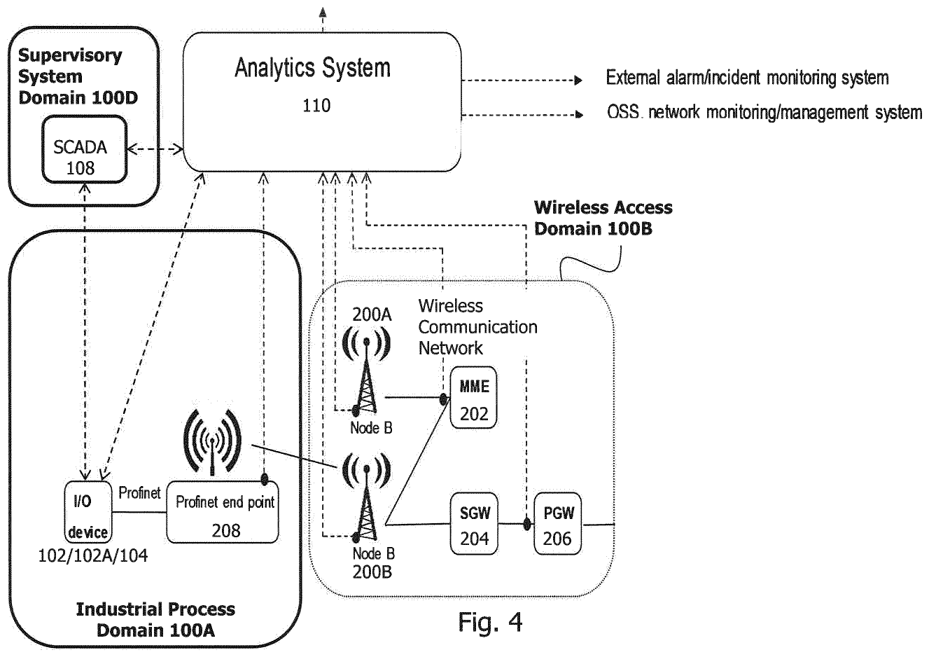

In the following, a further embodiment of a network system 100 will be described with reference to FIG. 4. The same reference numerals as in FIG. 1 will denote the same or similar components.

As shown in FIG. 4, the industrial process domain 100A, such as the robot cell domain 100A of FIG. 1, comprises one or more devices with I/O capabilities (“I/O devices” hereinafter), such as the local controllers 102A and monitoring devices 104 of FIG. 1.

The one or more I/O devices are connected via a one or more field buses to a wireless endpoint 208 within the industrial process domain 100A. In the present embodiment, it will be assumed that ProfiNet is used as communication protocol on the communication link between the one or more I/O devices (and, thus, the industrial process) and the wireless (ProfiNet) endpoint 208.

The wireless access domain 100B comprises a mobile wireless communication network with one or multiple base stations 200A, 200B (such as two Node Bs), a Mobility Management Entity (MME) 202, a Serving Gateway (SGW) 204 and a Packet Gateway (PGW) 206.

The local controllers 102A (e.g., PLCs) and, optionally, other I/O devices of the industrial process domain 100A are supervised by the SCADA controller 108 in the supervisory system domain 100D that captures event records from within the industrial process domain 100A. The SCADA controller 108, thus, has various capturing points within the industrial process domain 100A. Also some of the functions of the SCADA controller 108 may be implemented in the industrial process domain 100A. Since SCADA is a hierarchically structured concept, other functions of the SCADA controller 108 (e.g., aggregating functions that deliver event records with aggregated information) may be implemented in the cloud computing domain (see reference numeral 100C in FIG. 1). As such, the supervisory system domain 100D may be distributed among the industrial process domain 100A and the cloud computing domain.

In the embodiment depicted in FIG. 4, the performance determination apparatus 110 that was illustrated as a separate component in the embodiment of FIG. 1 has been incorporated into an analytics system as conventionally used for cellular communication networks. Exemplary analytics system frameworks also usable in the present context have been defined by 3GPP (see, e.g., 3GPP TS 23.002 V15.0.0 (2018-03) for a 4G communication network or 3GPP TS 23.501 V15.2.0 (2018-06) for a 5G communication network).

As illustrated in FIG. 4, the analytics system 110 is configured to capture event records from different system domains and network nodes. The associated capturing points are highlighted in FIG. 4.

The capturing points at the base stations 200A, 200B provide event information regarding radio conditions in the uplink and the downlink between the industrial process domain 100A and the wireless access domain 1006. In the downlink, RSRP and RSRQ information as defined by 3GPP may be collected. The RSRP and RSRQ information is indicative of signal strength and signal quality, respectively. In the uplink, the captured event information pertains to potential power restriction measures and SINR.

The capturing point at the MME 202 provides mobility-related event information. Such mobility-related event information may pertain to handovers (e.g., handover attempt, handover success and/or handover time). A handover is a critical process in mobile networks and, therefore, significantly influences control performance within the industrial process domain 100A.

As also illustrated in FIG. 4, a further capturing point is located at an interface of the PGW 206 towards the SGW 204. At this interface, event information pertaining to user plane traffic can be captured, such as information pertaining to control requests, associated responses and the related timing information.

As further illustrated in FIG. 4, another capturing point is located within the industrial process domain 100A and provides status information about the one or more I/O devices. Still further, the analytics system 110 also captures event information from the SCADA controller 108 of the one ore PLCs 102A.

The event information captured from the wireless access domain 100B, the industrial process domain 100A as well as the supervisory system domain 100D is transmitted in event records to the analytics system 110 and correlated there (as explained with reference to FIG. 3 above) so as to obtain correlation records including event information pertaining substantially to the same period of time as defined, for example, by a PLC operating cycle. The resulting correlation records include event information such as jitter (as collected from the wireless access domain 100B), reading inputs (I/O Image Table information), writing outputs (actuator position, time stamp and request ID) and processing communication requests from the industrial process domain 100A, and SCADA alarms (generated, e.g., when certain alarm conditions are satisfied) or CPU or other diagnostics information from the supervisory system domain 100D.

In some variants, the correlation steps are performed by the analytics system 110 in real-time and the correlation results are separately grouped per I/O device and/or per PLC cycle. From the correlation records, the analytics system 110 calculates one or more high level performance indicators, such as ProfiNet profile conformity level and/or device synchronization level. These high level performance indicators are related to low level performance indicators that characterize the control performance of the different system domains illustrated in FIG. 4, in particular the industrial process domain 100A and the wireless access domain 100B. If any of the high level performance indicators indicates a performance issue, the low level performance indicators will be analyzed for identifying the root cause of the performance issue.

The analytics system 110 is also configured to generate incidents when any of the calculated performance indicators, especially the high level performance indicators, do not meet required target values. Depending on the system domain in which the performance issue has been identified, the performance issue can be reported as an incident to an OSS of the wireless communication network or to an incident monitoring system of the industrial process domain 100A. Moreover, the analytics system 110 also can take action in regard of the one or more PLCs 102A, for example by changing controller set points in accordance with an identified performance issue.

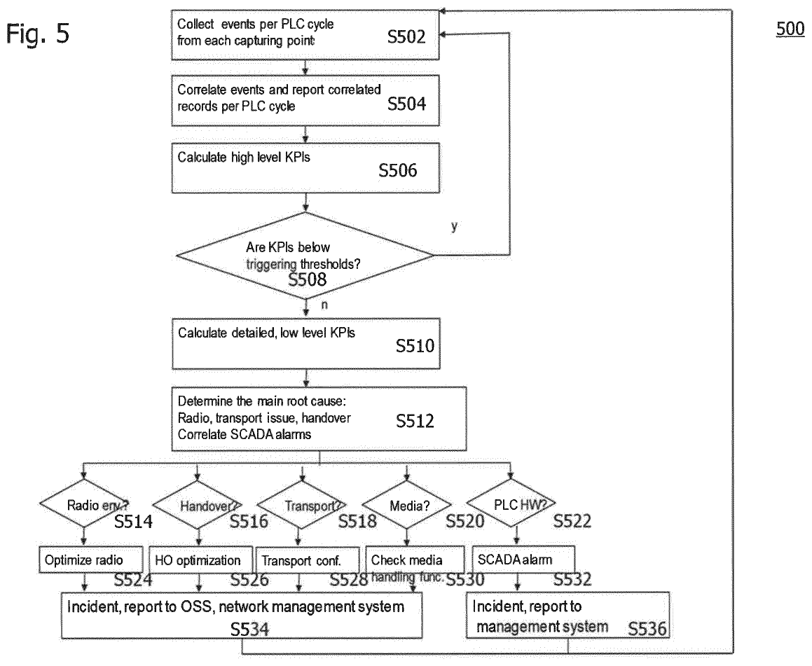

In the following, the operation of the network system embodiment illustrated in FIG. 4 will be described in more detail with reference to the flow diagram 500 of FIG. 5.

Referring to FIG. 5, in step S502 event records are collected per PLC cycle from multiple capturing points (e.g., as illustrated in FIG. 4). Then, in step S504, the event records are correlated and the correlated event records are reported per PLC cycle to step S506. In step S506, high level performance indicators (KPIs) are calculated. It will be appreciated that steps S502 to S506 generally correspond to steps S302 to S306 in FIG. 3, respectively.

The high level KPIs calculated in step S506 based on the collected event information are used for monitoring performance of industrial process control within the industrial process domain 100A and to identify possible performance issues. As will be explained in greater detail below, identification of a performance issue will trigger root cause analysis based on low level KPIs.

The high level KPIs may include a ProfiNet profile conformity level (e.g., pertaining to the requirements fulfilled in regard to a specific ProfiNet profile, such as ProfiSafe, ProfiDrive and ProfiEnergy). The high level KPIs may also relate to a service synchronization level, as for example defined by Rtp=(Tend−Treq)/Treq, where Treq the requested time for arrival of, for example, a robot arm at a requested position and Tend is the actual time needed (the requests may be issued by a local controller 102A associated with the robot arm). The high level KPIs may further be based on an occupied TTI-ratio due to bandwidth reservation of ProfiNet frames, and a scheduler preemption rate of ProfiNet frames.

The high level KPIs calculated in step S506 are then individually compared to associated predefined threshold values in step S508. These threshold values can be configurable by an operator of the analytics system 100. A performance issue may be determined if a single threshold is violated or if a predefined set of thresholds is violated. For example, a performance issue may be determined if for a current ProfiNet profile the value of Rtp exceeds a specific threshold (e.g., Current Profile=ProfiSafe and Rtp>0.1).

If no performance issue is determined in step S508, the method loops back to step S502. Step S502 to S508 may be performed in real-time. If, on the other hand, a performance issue is determined in step S508, the method proceeds to step S510. In step S510, multiple low level KPIs are determined (e.g., calculated) to identify the system domain responsible for the performance issue. The low level KPIs determined in step S510 may be included in or calculated on the basis of the more granular event information in the correlation record for which the performance issue was identified.

In step S512, root cause analysis for the performance issue is performed. In this regard, individual measurement values in a correlation record may be subjected to threshold decisions to identify the system domain that has caused the performance issue. It may, for example, be determined that the root cause of the performance issue is to be found in the wireless access domain (e.g., because of a radio issue in regard of the base stations 200A, 200B, a transport layer issue in regard of the PGW 206 or a handover issue in regard of the MME 202) or in the local controller domain (which will be identified as SCADA alarm).

In the following, a few examples of root cause analysis based on exemplary low level KPIs relating to the wireless access domain 100B will be given:

RSRP<−120 dBm: radio coverage issue
RSRQ<−15 dB: interference issue
Handover (HO) execution time>100 ms or HO success rate<0.95: HO issue
Packet loss>0.05 or Round Trip Time (RTT)>100 ms: transport issue
SCADA Web access time>1 s or web access failure rate>0.05: web server or media issue

Examples of root cause analysis based on exemplary low level KPIs relating to the local controller domain include (possibly aggregated) PLC-related diagnostics information such as CPU utilization, power status and so on.

Depending on whether the root cause pertains to the radio environment, handover-related aspects, transport-related aspects, media-related aspects or the local controller hardware (PLCs 102A) as determined in steps S514 to S522, respectively, appropriate action is taken. The appropriate action can be an optimization of the radio transmission parameters, a handover optimization, a change of a transport layer configuration, a check of the media handling functions or a SCADA alarm-triggered action, see steps S524 to S532, respectively.

In case the performance issue is attributable to the wireless access domain, in a further step S534 an incident is reported to the OSS (network management system) of the wireless access network. If, on the other hand, the performance issue is attributable to the local controller domain, an incident is reported in step S536 to an incident management/monitoring system pertaining to the controlled industrial process and/or the supervisory system (e.g., an alarm may be reported to the SCADA controller 108).

As has become apparent from the above description of exemplary embodiments, the present disclosure provides a multi-stage performance monitoring and optimization approach that is based on correlation of event information from different system domains. As a consequence, local controller communication through a wireless access network can be troubleshooted and optimized. This leads to the provision of a Quality of Service (QoS) framework for local controller communication.

While the present disclosure has been described with reference to exemplary embodiments, it will be appreciated that the present disclosure can be modified in various ways without departing from the scoop of the present disclosure as defined in the appended claims.

1. An apparatus configured to determine performance of industrial process control, at least one local controller of an industrial process is coupled via a wireless communication network to a central controller and the at least one local controller is supervised by a supervisory system that captures operational information from the at least one local controller, the apparatus being configured to:
receive first event records captured from the wireless communication network;
receive second event records captured from the supervisory system;
correlate at least the first and second event records that pertain to substantially the same period of time in a correlation record;
determine at least one first performance indicator on the basis of information included in one or more correlation records;
evaluate the at least one first performance indicator to identify a performance issue; and
if a performance issue is identified, determine a system domain in which the performance issue has occurred, wherein the system domain is selected from at least a wireless access domain and a local controller domain.

2. (canceled)

3. The apparatus of claim 1, wherein the at least one first performance indicator relates to a high system level, and wherein, if a performance issue is identified, one or more second performance indicators relating to a low system level are analysed to determine the system domain in which the performance issue has occurred.

4. The apparatus of claim 3, wherein the at least one second performance indicator is selected from the group comprising at least Reference Signal Received Power, RSRP, Reference Signal Received Quality, RSRQ, handover execution time, packet loss, Signal-to-Interference-plus-Noise Ratio, SINR, transmit power, a Hybrid Acknowledgement Repeat Request-, HARQ-, related parameter, supervisory system Web access time, video buffering time of a camera monitoring the industrial process, video stall time of the camera, supervisory system alarms, and diagnostics information from the supervisory system.

5. The apparatus of claim 4, wherein the at least one second performance indicator is received with at least one of:
one of the first event records;
one of the second event records; and
a third event record captured by the camera.

6. The apparatus of claim 1, further configured to report the performance issue dependent on the system domain in which the performance issue has occurred.

7. The apparatus of claim 6, further configured to report the performance issue to an Operations Support System, OSS, of the wireless communication network if the performance issue is attributable to the wireless access domain, and to report the performance issue to at least one of the supervisory system and an incident management system of the industrial process if the performance issue is attributable to the local controller domain.

8. The apparatus of claim 1, wherein the at least one local controller is located on level 1 of the Open Systems Interconnection, OSI, model and the supervisory system is located on level 2 of the OSI model.

9. The apparatus of claim 1, wherein the at least one local controller is connected to the supervisory system via a communication technique different from the wireless communication network.

10. The apparatus of claim 1, wherein the at least one local controller has an operating cycle, and wherein the period of time has a duration that corresponds to one or multiple operating cycles of the at least one local controller.

11. The apparatus of claim 1, wherein at least some of the first event records are indicative of at least one of a radio condition-related parameter, a mobility-related parameter, and a user plane traffic-related parameter.

12. The apparatus of claim 1, wherein at least some of the second event records are indicative of an event generated by the supervisory system based on the operational information captured from the at least one local controller.

13. The apparatus of claim 1, further configured to perform the receiving and correlating operations in real-time.

14. The apparatus of claim 1, further configured to adjust at least one operational parameter of the at least one local controller based on an analysis of the at least one first performance indicator.

15. The apparatus of claim 1, wherein the at least one first performance indicator is selected from the group comprising at least
a profile conformity level for an industrial communication protocol utilized for a communication link between a local endpoint of the wireless communication network and the industrial process;
a synchronization level for one or more devices involved in the industrial process;
an occupied Transmission Time Interval-, TTI-, related parameter due to bandwidth reservation for frames of the industrial communication protocol; and
a scheduler preemption-related parameter for frames of the industrial communication protocol.

16. The apparatus of claim 1, configured to receive one or more third event records captured from at least one monitoring device that monitors the industrial process; and
correlate at least the first, second and third event records that pertain to substantially the same period of time in the correlation record.

17. The apparatus of claim 16, wherein the one or more third event records are indicative of at least one of:
a measurement parameter from a sensor associated with an actuator controlled by the at least one local controller; and
information relating to a camera having a field of view including at least a part of the industrial process.

18. The apparatus of claim 16, wherein the one or more third event records are received via the wireless communication network.

19. The apparatus of claim 16, wherein two or more monitoring devices are configured to transmit their third event records via different wireless links to the wireless communication network, and wherein the apparatus is configured to perform the correlation per monitoring device.

20.-23. (canceled)

24. A method for determining performance of industrial process control, at least one local controller of an industrial process is coupled via a wireless communication network to a central controller and the at least one local controller is supervised by a supervisory system that captures operational information from the at least one local controller, the method comprising:
receiving first event records captured from the wireless communication network;
receiving second event records captured from the supervisory system;
correlating at least the first and second event records that pertain to substantially the same period of time in a correlation record;
determining at least one first performance indicator on the basis of information included in one or more correlation records;
evaluating the at least one first performance indicator to identify a performance issue; and
if a performance issue is identified, determining a system domain in which the performance issue has occurred, the system domain is selected from at least a wireless access domain and a local controller domain.

25-27. (canceled)
